(19) United States
(12) Patent Application Publication
(10) Pub. No.: US 2020/0187503 A1
(43) Pub. Date: Jun. 18, 2020

(54) PHEROMONE CLATHRATES

(71) Applicant: AGRORIM LTD., Kfar Qari (IL)

(72) Inventor: Jallal GNAIM, Kfar Qari (IL)

(21) Appl. No.: 16/802,556

(22) Filed: Feb. 27, 2020

Related U.S. Application Data
(63) Continuation-in-part of application No. PCT/IL2018/050947, filed on Aug. 27, 2018.
(60) Provisional application No. 62/550,636, filed on Aug. 27, 2017.

(51) Int. Cl. A01N 43/90; A01N 25/08; A01N 31/02; A01N 37/02

(52) U.S. Cl. CPC A01N 43/90; A01N 37/02; A01N 31/02; A01N 25/08

(57) ABSTRACT

A slow-release composition comprising: first host material comprising a mesoporous molecular sieve; guest material within the first host material, the guest material comprising at least one pheromone, wherein the pheromone is selected from a group consisting of: 1,7-dioxaspiro-5,5-undecane; Z-7-Tetradecenal; E-11-hexadecenal; E-11-Hexedecenyl-1-acetate; E,E-8,11-dodecandien-1-ol; Z,E-9,11,13-Tetradecatrienal, and E,Z,Z-3,8,11-Tetradecatrienyl acetate, and mixtures thereof.

### DETAILS OF RELATED APPLICATIONS

This application is a continuation in part (CIP) of PCT/IL2018/050947 filed on 27 Aug. 2018 and subsequently published as WO/2019/043697 on 7 Mar. 2019, said PCT application claiming the benefit of U.S. provisional application 62/550,636 filed on 27 Aug. 2017 according to 35 U.S.C. § 119 (e); Each of these earlier applications is fully incorporated herein by reference.

### BACKGROUND

Pesticides are one of several broad technologies used to grow the food needed to feed the threefold growth in the world's population since 1950. Unfortunately, the use of pesticides has also caused tremendous damage to the world's environment, and much of this damage is long lasting because of the effects of persistent organic pollutants and bioaccumulation of toxic substances.

Integrated Pest Management (IPM), which has been in continuous development since the 1950s manages to greatly reduce the use of pesticides while not usually harming yields. The principles of IPM, which has been applied in different ways for different crops over the years, are avoidance of prophylactic use of pesticides, monitoring crops for pest infestation, determining thresholds that demand intervention and staged use of various tools against infestation with traditional pesticides usually acting as the last intervention if other tiers fail. Of particular interest are the push-pull variants of IPM developed during the past decade that use semiochemicals, pheromones or other chemicals that convey a signal from one organism to another so as to modify the behavior of the recipient organism, to either attract or repel pests. The use of semiochemicals to modify pest behavior increases the efficacy of IPM, and in some cases allows crops to be harvested without use of any pesticides at all.

As an approach, IPM has many advantages, mainly in its adaptability to various crops, climates and economic circumstances. But it must be stressed that it is an approach rather than a discrete technology which means that measurements of its efficacy can never be performed on a broad scale but only in case by case comparisons. As an approach its advantages, as many studies show, is that it can equal or in some cases exceed the yields of crops grown with traditional use of insecticides. This reduces the risk of insects developing resistance (as they often do) to specific insecticides, reduces direct cost of insecticides applications, reduces risks of insecticides traces in produce, and reduces potential damage to farm workers' health while protecting the general environment from the deleterious effects of the insecticides. The disadvantages include a higher level of knowledge needed by the farmer; more labor costs, and in some cases a higher percentage of blemished fruit.

Most agronomical experts agree that the advantages of IPM far outweigh the disadvantages, yet its acceptance has been in general slower than many anticipated a few decades ago. One of the major problems has been the complexity of IPM implementation and the amount of time it demands from farmers. Another major problem is that pheromones, one of the most potent tools in the IPM tool chest, are hard to apply in a manner that is easy and cost effective for farmers. Insect sex pheromones, by their nature, must be small-size molecules with relatively low molecular weight and high volatility that are released in the air during key times of the breeding cycle to attract insects to mating targets. Both the volatility and instability are problems. Resolution of these problems can greatly increase the use of pheromones in the market and increase the application of IPM principles.

Pheromones can be used in four ways in IPM applications.

Monitoring: pheromone based lures are needed to alert the farmer to the pest's presence to start the tiered IPM intervention.

Mass trapping: pheromone lures can attract insects of one sex to traps and thus reduce the number of fertile insects available for mating.

Mating disruption: Pheromones can offer false lures to insect seeking mates thus reducing the effectiveness of the mating process and the number of eggs laid in crops.

Part of push-pull IPM solutions: either on the push side by using alert pheromones or on the pull side by using sex pheromones.

A functional problem facing use of pheromones in each of these four applications is that pest control systems that involve use of pheromones must be in tune with the breeding cycles of the pests. In many if not most pests there are several breeding cycles during the years with a large degree of overlap, meaning that not all females start releasing sex pheromones during the exact same day or week. This means that IPM solutions that use pheromones must be attractive for the pest during the entire season.

Zeolites and clays are aluminosilicate minerals of alkali or alkaline earth metal which contain crystal water. Their general chemical formula is AₘXₚO₂ₚ.nH₂O, where A represents Ca, Na, K, Ba, and Sr; X represents Al and Si and m, p and n are integers. Aluminosilicates consist of three dimensional networks of AlO₄ and SiO₄ tetrahedra linked by sharing of all oxygen atoms. The aluminosilicate frameworks are remarkably open and contain channels, and interconnected voids partially filled with cations and water molecules. The intracrystalline voids make up from 20 to 50% of the total crystal volume of most zeolites.

### SUMMARY

According to one aspect of the disclosure, compositions are provided that each comprise at least one host material, each hosting a guest material such as a pheromone, for example oleane.

Some embodiments comprise host materials that have desirable and improved guest material release profiles.

According to one aspect of the disclosure, compositions are provided that each comprise a mixture of host materials, each host material hosting a guest material such as a pheromone, for example oleane.

In some particular embodiments the mixture is selected to provide clathrates having complementary guest material release properties, such that guest material is first predominantly released at a high rate and then predominantly released at a substantially slower rate.

According to one aspect of the disclosure, a slow-release composition is provided comprising: first host material comprising

a mesoporous molecular sieve;

guest material within the first host material, the guest material comprising at least one pheromone, wherein the pheromone is selected from a group consisting of: 1,7-dioxaspiro-5,5-undecane; Z-7-Tetradecenal; E-11-hexadecenal; E-11-Hexedecenyl-1-acetate; E,E-8,11-dodecandien-1-ol; Z,E-9,11,13-Tetradecatrienal, and E,Z,Z-3,8,11-Tetradecatrienyl acetate, and mixtures thereof.

In some embodiments the mesoporous molecular sieve is selected from: silica; Al₂O₃, K-10 Montmorillonite and derivatives thereof, and mixtures thereof.

According to another aspect of the disclosure, a slow-release composition is provided comprising: A variable-release composition comprising:
first host material comprising a mesoporous molecular sieve;

second host material selected from a second group consisting of: Na—X and derivatives thereof, Na—Y and derivatives thereof, and mixtures thereof;

guest material within the first host material and within the second host material, the guest material comprising at least one pheromone, wherein the pheromone is independently selected for each of the first host material and the second host material from a group consisting of: 1,7-dioxaspiro-5,5-undecane; Z-7-Tetradecenal; E-11-hexadecenal; E-11-Hexedecenyl-1-acetate; E,E-8,11-dodecandien-1-ol; Z,E-9,11,13-Tetradecatrienal, and E,Z,Z-3,8,11-Tetradecatrienyl acetate, and mixtures thereof.

In some embodiments the mesoporous molecular sieve consisting of: silica; Al₂O₃, K-10 Montmorillonite and derivatives thereof, and mixtures thereof.

In some embodiments the composition is not incorporated into a matrix made of a polymeric material.

In some particular embodiments the first host material consists of silica.

Some embodiments further comprise spinosids.

In some embodiments the spinosids comprise spinosyn A and spinosyn D. In some embodiments spinosyn A and spinosyn D are in a w/w ratio respectively of 20/1 to 15/5. In some embodiments the ratio is between 16/4 and 18/2.

In some embodiments Na—X and derivatives thereof is selected from a group consisting of: Na—X; H—X, Zn—X, Ca—X, K—X and combinations thereof.

In some embodiments Na—Y and derivatives thereof is selected from a group consisting of: Na—Y; K—Y, Ca—Y, Zn—Y, H—Y, NH₄—Y, Al—Y, and combinations thereof.

Some embodiments further comprise at least one protective agent, the protective agent being effective in protecting the guest material against at least one of a group consisting of oxidation, photodegradation, hydrolysis, and thermal decomposition.

In some embodiments the at least one agent is situated in the first host material or adjacent thereto.

In some embodiments the agent is at least one antioxidant.

Some embodiments comprising an opaque coating on the first host material.

Some embodiments further comprise an opaque coating on the first host material and/or second host material.

According to yet another aspect a dispenser is provided comprising any of the compositions defined above.

In some embodiments the dispenser is essentially opaque.

According to another aspect of the disclosure a product or process are provided substantially as described below with reference to any one of the Examples, tables and/or to any one of the accompanying drawings.

### Definitions

A mesoporous material: a material containing pores with diameters typically between 2 and 50 nm.

A clathrate: an inclusion compound in which a guest molecule is in a cage formed by a host molecule or by a lattice of host molecules.

Molecular sieve: a material with pores of essentially uniform size.

In the discussion unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the specification and claims is considered to be the inclusive “or” rather than the exclusive or, and indicates at least one of, or any combination of items it conjoins.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF FIGURES

FIG. 1 illustrates the loading and release of oleane from silica;

FIG. 2 illustrates the loading and release of oleane from Al₂O₃,

FIG. 3 illustrates the loading and release of oleane from K-10 Montmorillonite (Na-K10);

FIG. 4 illustrates the loading and release of oleane from Al-K10;

FIG. 5 illustrates the loading and release of oleane from Ca-K10;

FIG. 6 illustrates the loading and release of oleane from Cu-K10;

FIG. 7 illustrates the loading and release of oleane from NaX (25° C.) zeolite;

FIG. 8 shows loading and release from H—X oleane clathrates;

FIG. 9 shows loading and release from Na—Y oleane clathrates;

FIG. 10 shows loading and release from K—Y oleane clathrates;

FIG. 11 illustrates a trial map for field-testing embodiments in a commercial organic olive orchard in the village Aara;

FIG. 12a shows the infection % of fruits by olive fruit fly larva as measured at harvest time in the trial at Aara;

FIG. 12b shows the infection % by olive moth in fruits on the day of harvest as Aara;

FIG. 13a illustrates the number of trapped adult olive fruit fly insects on the monitoring traps by treatments and counting, following application of treatments (10DAT1=10 days after treatment, 24DAT1=24 days after treatment, 37DAT1=37 days after treatment) in the trial at Aara;

FIG. 13b depicts the number of trapped adult olive moth insects in the monitoring traps by treatments and counting dates following application of treatments (10DAT1=10 days after treatment, 24DAT1=24 days after treatment, 37DAT1=37 days after treatment) in the trial at Aara;

FIG. 14 present a trial map for a trial in Kfar Qari, and

FIG. 15 illustrates the infection % of fruits by olive fruit fly larva in the trial in Kfar Qari.

Non-limiting examples of embodiments of the invention are described below with reference to figures attached hereto that are listed following this paragraph. Identical structures, elements or parts that appear in more than one figure are generally labelled with a same numeral in all the figures in which they appear. Dimensions of components and features shown in the figures are chosen for convenience and clarity of presentation and are not necessarily shown to scale.

### DETAILED DESCRIPTION

In the detailed description below, pertaining to improved compositions comprising host materials and guest materials, the compositions also referred to below as “clathrates”. Their syntheses and methods of use are described.

Pest control systems that involve use of pheromones require a suitable host material to store and release the pheromones. One purpose of some embodiments described below is to provide clathrates comprising pheromones, that can slowly release the pheromones, to provide prolonged effective treatment against pests, to minimize frequency of expensive and labor intensive treatment for example.

Another purpose of some embodiments described below is to provide compositions wherein the guest pheromones are highly loaded in their host materials, to prolong an effective treatment and/or provide high release rates, at least at initial periods of the release.

Criteria for host material selection in clathrates for pheromone dispensing are generally as follows:

1. Particle size—to provide sufficient surface area
2. Particle cavity and channel shape—to fit guest pheromones
3. Matrix structure to allow desired equilibrium and release rate
4. Host Polarity—to suit host-guest interactions

See for example EP1064843, which describes a process for preparing an emitter for controlled and durable release of a semiochemical substance (n-decyl alcohol, trimedlure, 2,3- or 2,5-dimethylpyracine) from a support selected from zeolites and aluminosilicates and aluminophosphates, wherein the process includes adapting physiochemical properties of the support to characteristics of the semiochemical substance and to specific needs of release kinetics, by modifying at least one property selected from Si/Al ratio, acidity, compensation cations, pore size, compactation and surface/weight ratio of the support.

Despite the general guidelines for host selection in EP1064843, selection of the host is largely empirical. Finding compositions that have a high loading of the pheromone/s as well as an extended release, with a high release remaining available after an extended period in the field, is difficult. Furthermore, a problem with the use of such clathrates is that often there is an immediate pest problem that needs to be swiftly dealt with, and subsequently there is a substantial danger of reinfestation within a short period after the immediate eradication. Modifying Si/Al ratio, acidity, compensation cations, pore size, compactation and surface/weight ratio of the support, for example, is generally not sufficient to solve such a problem.

Therefore, another purpose of some embodiments described below is to provide compositions that have a release rate and/or rate constant that is highest upon initial exposure of the compositions to field conditions, i.e. under conditions similar or identical to the conditions under which they are intended to be used, and at a lower rate/rate constant thereafter, such as to solve the problem of how to provide both immediate treatment of infestation and prevention of reinfestation in one treatment. Some embodiments that exhibit an inconstant rate/and or variable rate constant of release for effective immediate treatment and prolonged treatment comprise a single host material but several guest materials, each host material particle typically hosting one guest material, e.g. oleane, whereas other embodiments comprise a mixture of host materials, each hosting a guest material. The proportion of each host material may be adjusted to achieve a desired release profile.

The compositions having a higher initial release rate and/or rate constant followed by a slower release rate and/or lower rate constant may allow quick eradication of pests in orchards, followed by a lengthy prophylactic treatment of the same orchards, with a single distribution of the composition, as opposed to pest treatment with commercially available compositions that typically require multiple treatments and high dosages over the life cycle of the targeted pest, as well as excessive and/or inadequate release and frequent monitoring against reinfestation.

According to one aspect, compositions are provided comprising at least one host material, each a solid support such as a meso-porous material, and guest material, for example a sex pheromone.

In some embodiments a pheromone composition is provided comprising at least one host material and from about 0.1% to about 35%, by weight of the composition, of a pheromone.

Typically, the pheromone is included within pores of the host material.

Some embodiments comprise host material selected from a group consisting of large-pore zeolites with channels having a free diameter from 12 Å to 5.9 Å, zeolites such as Clinoptilolite, Beta, Linde X, Linde Y, Linde L, Mordenite, and mixtures thereof.

Some embodiments comprise host material selected from a group consisting of medium-pore zeolites with channels having a free diameter from 5.9 Å to 5.0 Å, such as ZSM-5, Silicalite, Ferrierite types, Linde-T, Merlinoite types, Linde W, and mixtures thereof.

In some embodiments the host material comprises clays selected from the group consisting of Kaolinite, montmorillonite KSF clay, montmorillonite K10 clay, and mixtures thereof. In some embodiments the host material consists of clays selected from said group.

Some embodiments comprise host material selected from the group consisting of ion-exchanged forms of the zeolites and clays described above. In some embodiments the compositions consist of compositions selected from said group.

In some embodiments the ion-exchanged materials are zeolites and clays cation-exchanged with metal ions, such as K⁺, Na⁺, Cs⁺, Be⁺², Cr⁺³, Ce⁺³, Cu⁺², Ca⁺², Mg⁺², Fe⁺², Fe⁺³, Ag⁺, Ba⁺² or Zn⁺², and mixtures thereof.

In some embodiments the host material is selected from the group consisting of hydrophobic (organophilic) pentasil zeolites with high Si:Al ratio.

In some embodiments the host material comprises compositions selected from the group of mesoporous solids consisting of silica SiO₂, aluminum oxide Al₂O₃, and mixtures thereof. In some embodiments the host material consists of mesoporous solids selected from said group.

In some embodiments the silica is provided in the form of silica gel.

The compositions may be provided as a powder, pellets, beads, or granules.

In some embodiments particle sizes of the clathrates are from about 1 micron to about 100 microns.

In some embodiments the compositions are provided as a suspension in liquid, for example in water.

Some embodiments further comprise at least one additive selected from the group consisting of protective colloids, adhesives, binding agents, chelating agents, thickening agents, thixotropic agents, penetrating agents, stabilizing agents, sequestering agents, anti-foam agents, antioxidants, natural or synthetic seasonings and/or flavors, dyes and/or colorants, vitamins, minerals, nutrients, enzymes, insecticides, deodorants, and mixtures thereof.

According to another aspect, a process is provided for preparing a composition comprising at least one pheromone as guest material and at least one mesoporous solid host material.

### Materials and Methods

### Method 1: Preparation of Clathrates

Solid host material was added to a solution of a pheromone in a hydrophobic solvent having a concentration of 10-15% w/w, until the concentration of the host material was 10-50% w/w in the mixture of host material, pheromone and solvent. The mixture was stirred at a controlled temperature for 2 h-overnight (about 12 hr), to create a suspension of the host material in the solvent and facilitate the incorporation of the guest material into the host material. The mixture was cooled to room temperature and vacuum filtered through a sintered filter disc size #1-3. The precipitate solid was washed with a small quantity of cold solvent and then vacuum dried at room temperature for 2-12 hr. The dried solid may then be packed in preparation for use.

In some embodiments the filtrate is recycled for further preparations of pheromone clathrates by adding some guest material to the filtrate and repeating the preparation as described above.

Suitable solvents are for example alkanes such as pentane, hexane, heptane, octane, iso-octane or haloalkanes such as dichloromethane, dichloroethane, chloroform, carbontetrachloride, dibromomethane, ethyl acetate or mixtures thereof.

The filtration may alternatively be carried out by regular filtration, centrifuge or freeze drying for example.

### Method 2: Preparation of Clathrates

A solid host material is calcined at a temperature of 100-400° C., as appropriate to the material, and is cooled protected from air to remain dry. The dry host material is placed in one flask, protected from air, and a pheromone is placed in another flask. The flasks are connected via a common tube and sealed from the atmosphere. The pheromone condenses on and within the host material. After 2-12 hr the clathrate can be removed from the flask and packaged.

### Method 3: Analyses of Clathrates

Loading of the guest material in the host material is determined by extraction of the guest material from the clathrates in an organic solvent and injection of the extracts into a GC-MS. The retention time of the pheromone guest material and the mass spectrum serve to identify the pheromone and to quantify the loading of the pheromone in the host material.

The clathrates are distributed in a field and samples are collected at various times and extracted for quantitative and qualitative analysis. Release profiles of the clathrates can be derived from the analysis results of the samples.

### Example 1: Loading and Release of Oleane from Oleane Clathrates

Table 1 summarizes the loadings of 36 various host materials with the guest material olive fruit fly pheromone oleane (1,7-dioxaspiro-5,5-undecane) for potentially suitable clathrates. Samples of the various host materials with oleane were simultaneously held in a field in Eppendorf tubes under temperatures generally varying between 15 and 35° C., and were collected from the field at various times and analyzed according to the analysis method 3 described above. The loadings, expressed in units of mg guest per g of host material in Table 1, decrease over time as a result of the release of the pheromone. The release rate of the pheromone can be inferred from the tabulated results. The pheromone is released as a result of replacement by water entirely originating from the humidity of the air.

TABLE 1

| | Host | Time (days) | | | | | | | | | | | | | |
|---|---|---|---|---|---|---|---|---|---|---|---|---|---|---|---|
| No. | material | 0 | 1 | 2 | 3 | 4 | 5 | 6 | 7 | 10 | 15 | 20 | 25 | 30 | 60 |
| 1 | Na-X (25) | 157.2 | 141.9 | 130.7 | 124.6 | 116.8 | 120.7 | 110.1 | 118.2 | 103.3 | — | 114.4 | 58.9 | 44.6 | 0 |
| 2 | Na-X (200) | 146.1 | 117.7 | 119 | nd | 118.2 | 114.1 | 107.2 | 103.8 | 95.8 | 82.2 | 51.9 | 46.8 | 62.6 | 0 |
| 3 | Na-X (300) | 140 | 122.8 | 116.4 | 115.6 | 111.2 | 106.3 | 104.8 | 102.7 | 83.8 | 61.5 | — | 40.6 | 25.3 | 0 |
| 4 | Na-X (400) | 130.3 | 108 | 105.1 | 105.6 | 99.5 | 101.4 | 100.9 | 96 | 79.3 | 65.5 | 45.5 | 26.6 | nd | 0 |
| 5 | Na-X (500) | 145.4 | 125.6 | 125 | 114 | 111 | 113.5 | 101.7 | 110.1 | 99.2 | 79 | 63.6 | 45.7 | nd | 0 |
| 6 | Na-X (600) | 157.7 | 114.7 | 120 | 112.4 | 107.9 | 112 | 90.3 | 107.3 | 89.4 | 75.3 | 61.2 | 24.8 | nd | 0 |
| 7 | H-X | 122 | 105.5 | 102.2 | 101.5 | 96.5 | 96.2 | 90.5 | 84.9 | — | 68.8 | 62.5 | 54.1 | nd | 31.6 |
| 8 | Cu-X | 33.8 | 28 | 24.7 | 18.9 | 16.8 | 12.6 | 8.8 | 8 | 8 | 5 | 5 | 5 | nd | 0 |
| 9 | K-X | 72.6 | 61.9 | 56.1 | 57.4 | 54.1 | 49.2 | 45.4 | 43.7 | 26.8 | nd | 0 | 0 | 0 | 0 |
| 10 | Zn-X | 175.9 | 139.3 | 135.4 | 121.9 | 105.6 | 115.2 | 97.6 | 96.8 | 94.2 | nd | 63.7 | 46 | 44.1 | 9.3 |
| 11 | Ca-X | 110.9 | 103.8 | nd | 86.8 | 98.2 | 109.9 | 100.1 | 75.7 | 65.8 | nd | 48.4 | 17.94 | 5.3 | 0 |
| 12 | 3A | 0 | 0 | 0 | 0 | 0 | 0 | 0 | 0 | 0 | 0 | 0 | 0 | 0 | 0 |
| 13 | 4A | 14.7 | 8.1 | 4.9 | 0 | 0 | 0 | 0 | 0 | 0 | 0 | 0 | 0 | 0 | 0 |
| 14 | 5A | 6.5 | 0 | 0 | 0 | 0 | 0 | 0 | 0 | 0 | 0 | 0 | 0 | 0 | 0 |
| 15 | Na-Y | 173.5 | 131.2 | nd | 130.6 | 121.3 | 119.4 | 114.2 | 109.5 | 79.1 | 57.3 | nd | 53.5 | 53.3 | 22.8 |
| 16 | K-Y | 178.1 | nd | 125.4 | 129.2 | 121.3 | 117 | 112.6 | 113.9 | 87.6 | 78.1 | nd | 62 | 41.5 | 4.9 |
| 17 | Ca-Y | 195 | nd | 144.2 | 139.6 | 132.9 | 125.7 | 126.6 | 110.9 | 97 | 105.6 | nd | 76.1 | 62.9 | 19.8 |
| 18 | SiO₂ | 173.7 | 177 | 178.1 | 170.5 | 177.3 | nd | 174.1 | 170.8 | 169.1 | 156.3 | 155.4 | nd | 167 | 150.5 |
| 19 | Al₂O₃ | 63.8 | 65.5 | 61.7 | 61.6 | 61.7 | nd | 57.9 | 53.9 | 52.4 | 45.9 | 42.4 | nd | 52 | 38.4 |
| 20 | Hydrophobic | 16 | 11.3 | 6.7 | nd | nd | nd | nd | 0 | nd | nd | nd | nd | 0 | 0 |
| 21 | Na-K10 | 92.1 | nd | 79.6 | 82.8 | 80.5 | nd | 78.3 | 73.5 | 71.9 | nd | 65.3 | 64 | 85.1 | 68.5 |
| 22 | Bent (400) | 31 | nd | 27.4 | 25.6 | 25 | 22.3 | 22.6 | 19.5 | 19 | nd | 12.4 | 12.2 | 10.3 | 7.2 |
| 23 | KSF | 10.1 | nd | nd | nd | nd | 0 | nd | nd | nd | nd | 0 | nd | nd | nd |
| 24 | H-5A | 8.8 | nd | nd | nd | nd | 0 | nd | nd | nd | nd | 0 | nd | nd | nd |
| 25 | Zn-Y | 220.4 | 147 | 142.6 | 141.7 | 136.5 | nd | 129 | 116.8 | 123.8 | 115.1 | 94.4 | 93 | 79.1 | nd |
| 26 | AW (300) | 19.9 | 17 | 15.8 | 12.3 | 10.9 | nd | 8.2 | 5.6 | nd | nd | 0 | nd | 3.8 | 0 |
| 27 | AW (500) | 29.5 | nd | nd | 20.7 | 18.2 | nd | 14.8 | nd | 12.7 | 10.6 | 9.1 | nd | 9 | nd |
| 28 | H-Y | 91.3 | 108.7 | nd | 79.1 | nd | nd | 73.5 | 58.6 | nd | 53.2 | 40.7 | nd | 22.3 | 0 |
| 29 | NH₄-Y | 176.7 | 154 | nd | 161.4 | nd | nd | 177.1 | 142 | 160.4 | 136.1 | 145.5 | nd | 129.3 | 82.2 |
| 30 | Al-Y | 61.5 | 74 | nd | 70 | nd | nd | 64.8 | 64.4 | 64.6 | 62.5 | 53.3 | nd | 48.2 | 26.2 |
| 31 | Al-K10 | 77.6 | 68.5 | 70.4 | 71 | nd | 68.9 | 74.6 | 75.6 | 81.2 | 64.6 | 106.5 | 68.9 | 59.3 | 44.4 |
| 32 | Ca-K10 | 96.5 | 100.6 | 87.6 | 99.5 | nd | 109.8 | 93.7 | 85.3 | 91.8 | nd | 70.4 | 82.6 | 66.1 | 58 |
| 33 | Cu-K10 | 81.9 | 51.17 | 45.19 | 40.5 | nd | 32.9 | nd | 30 | nd | 13.8 | nd | 14.2 | 8.6 | nd |
| 34 | Zn-5A | 21 | nd | nd | nd | nd | nd | nd | 6.7 | nd | nd | nd | nd | 0 | nd |
| 35 | Ag-5A | 7.1 | nd | nd | nd | nd | 0 | nd | nd | nd | nd | 0 | nd | nd | nd |
| 36 | Cu-5A | 30.6 | nd | nd | nd | nd | 0 | nd | nd | nd | nd | 0 | nd | nd | nd |

nd = not detected

Numbers in parentheses represent the dehydration temperatures of the host materials.

In Table 1:

Na—X is a synthetic zeolite of sodium aluminate and sodium silicate, wherein the silica-to-alumina ratio is between 2 and 3;

H—X, Cu—X, K—X, Zn—X, Ca—X:Na—X are synthetic Na—X zeolites in which the sodium is respectively substituted with hydrogen, copper, potassium, zinc or calcium;

3A is a zeolite having an approximate chemical formula: ⅔K₂O.⅓Na₂O.Al₂O₃.2 SiO₂.9/2 H₂O and silica-alumina ratio: SiO₂/Al₂O₃≈2, wherein the zeolite can adsorb molecules whose diameters are smaller than 3 Å;

4A is a zeolite like 3A, except the zeolite can adsorb molecules whose diameters are smaller than 4 Å

5A is a zeolite like 3A, except the zeolite can adsorb molecules whose diameters are smaller than 5 Å;

Na—Y is a synthetic zeolite of sodium aluminate and sodium silicate, wherein the silica-to-alumina ratio is over 3;

K—Y, Ca—Y, Zn—Y, H—Y, NH4-Y, Al—Y are synthetic Na—Y zeolites in which the sodium is respectively substituted with potassium, calcium, zinc, hydrogen, ammonium or aluminum;

Hydrophobic is a pentasil;

Na-K10 is a sodium-substituted montmorillonite clay (a clay having two tetrahedral sheets of silica sandwiching a central octahedral sheet of alumina) having a surface area of about 250 m²/g;

Bent (400) is a bentonite

(an absorbent aluminum phyllosilicate clay consisting mostly of montmorillonite);

KSF is an acidic montmorillonite clay having a surface area of about 10 m²/g;

H-5A, Zn-5a, Ag-5A and Cu-5A are zeolites like 5A in which the sodium is respectively substituted with zinc, silver or copper;

AW (300) is NaZ [(AlO₂)x(SiO₂)Y].24H₂O molecular sieves in the form of 1.6 mm sized pellets;

AW (500) is CaZ[(AlO₂)X(SiO₂)Y].13H₂O with 4 Å sized pores; Al-K10, Cu-K10 and Cu-K10 are montmorillonite clays like Na-K10 in which the sodium is respectively substituted with Aluminum, potassium or copper.

The desired clathrates have high-medium loading, i.e., over 5% w/w of pheromone in clathrate.

It is Apparent from Table 1 that about a third of the tested clathrates failed to adequately load.

All of the host materials listed in Table 1 theoretically had the desired pore size, sufficient to accommodate oleane. The small pore size provided a relatively large surface area per unit weight of the host material, an extremely important criterion for allowing a high loading rate for the overall packing of the host material with its pheromone. However, only 23 of them significantly loaded with the pheromone and were thus initial candidates for use in the field for pest management.

WO2012072366 describes that suitable carriers (hosts) for pheromones have typical pore widths of 3, 4, 5, 10, and 13 Angstroms, with a pore width of 5 to 15 Angstroms, especially 8 to 3 Angstroms, being preferred. However, in our experience, despite knowledge of the structures and pore dimensions of the host materials, considerable empirical effort was required to find suitable host materials. Moreover, in contrast to WO2012072366, for the guest materials tested in this disclosure we have surprisingly found that host materials with larger pore sizes characterizing mesoporous host materials (2 to 50 nm, i.e., 20 to 500 Å) generally yield superior results. For example, silica, Al₂O₃; K-10 Montmorillonite (Na-K10) and its derivatives, such as Al-K10, Ca-K10, Cu-K10 are all mesoporous host materials: Compare their loading and release rates in Table 1 with the other host materials in Table 1, as further discussed below.

Some of the host materials were found to be particularly suitable for the purpose of controlled release of the pheromone, exhibiting exceptionally high loading capacities of over 15%.

In particular, mesoporous silica, preferably in silica gel form, can be used to host oleane or a pheromone of similar size at a high loading and with slow release. At present I believe that the silica clathrate embodiments operate most efficiently, but other embodiments described below are also satisfactory.

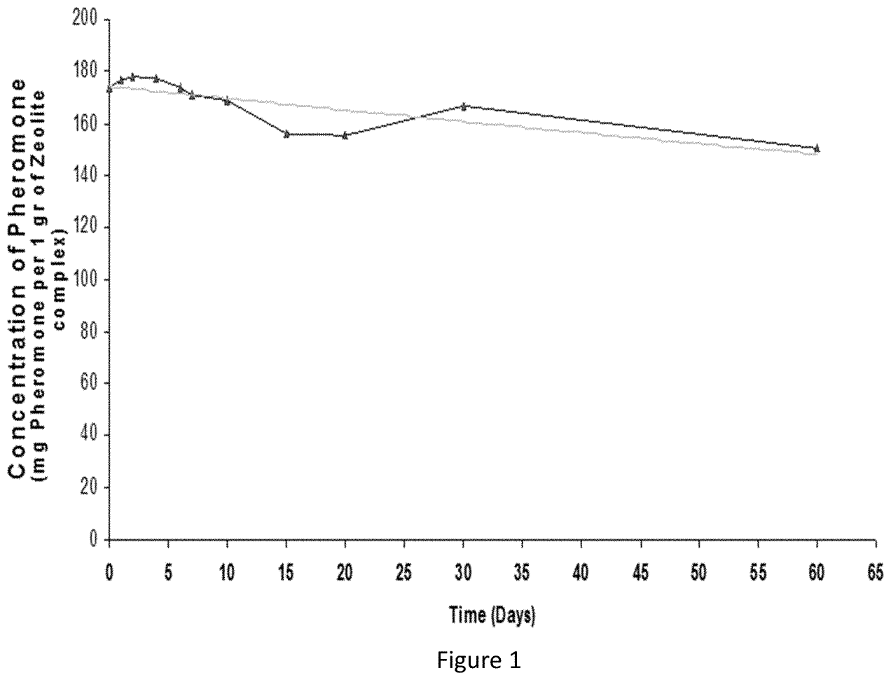

FIG. 1 illustrates the loading and release of oleane from silica. The points in Graph 1 represent corresponding data in Table 1 for silica clathrates.

Silica (SiO₂) has a particularly surprisingly high loading of oleane and a protracted release of the pheromone, starting with a load of over 17% and still holding a load of over 14% after 60 days. Extrapolation of the results for silica (not shown) shows that the host material remains potent after 14 months' exposure to field conditions. The prolonged efficacy in very advantageous, since free oleane is highly volatile, and treatment of the affected fields/orchards is very costly and labor-intensive. Repeat treatment is minimized under the proposed regime.

Note that some silica, for example artificial silica or silica that undergoes treatment such as high temperatures, may have pore sizes that are not mesoporous, i.e., less than 2 nm or more than 50 nm size. Such silica is considered to be less suitable for loading and release of the pheromones considered herein.

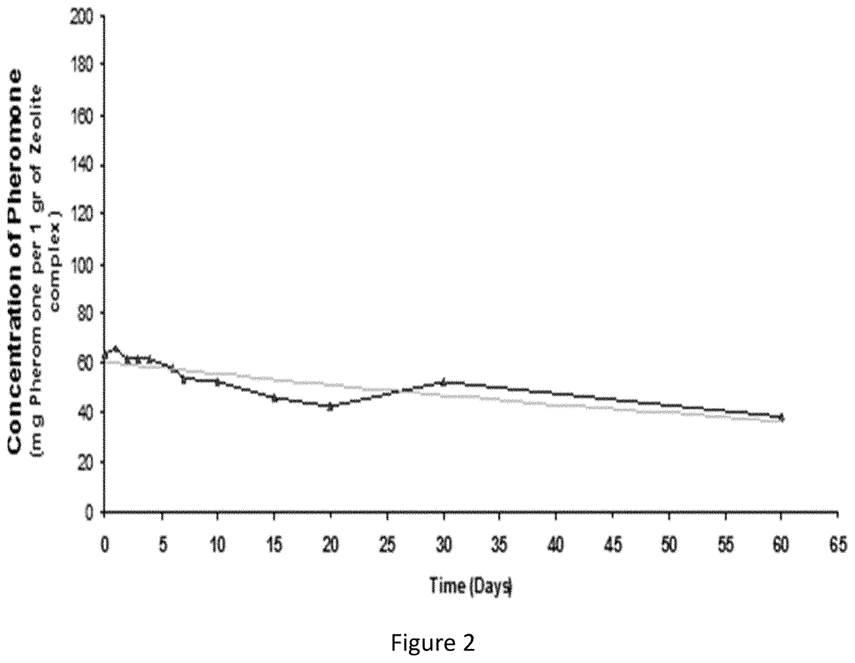

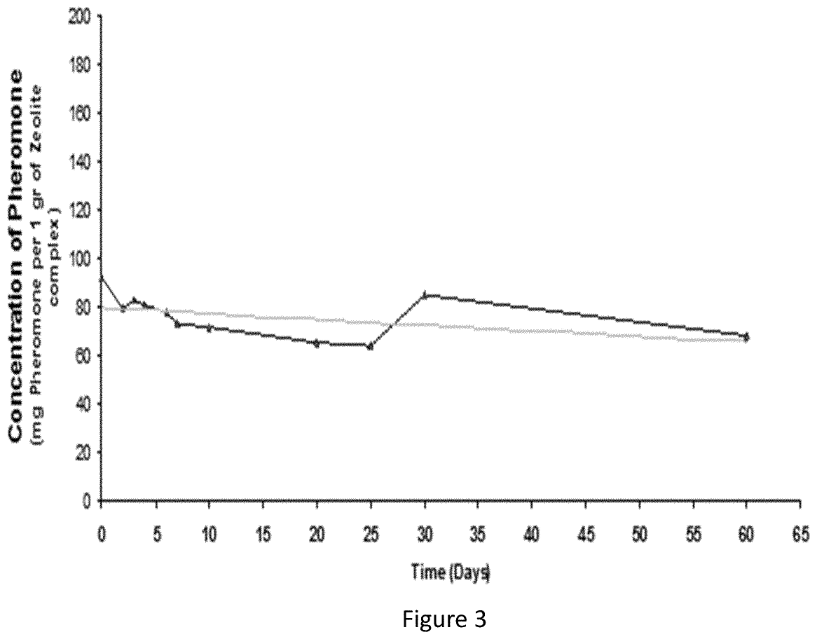

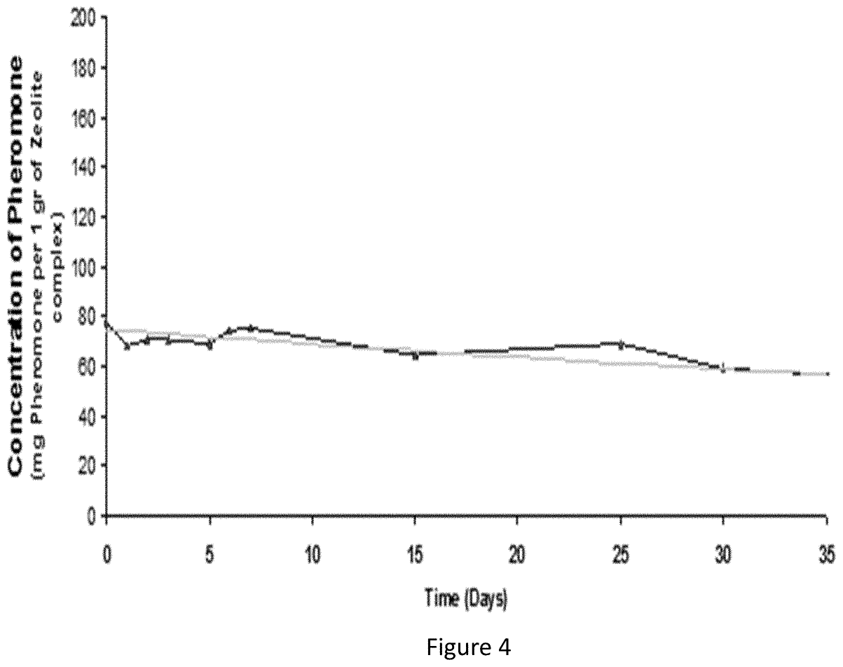

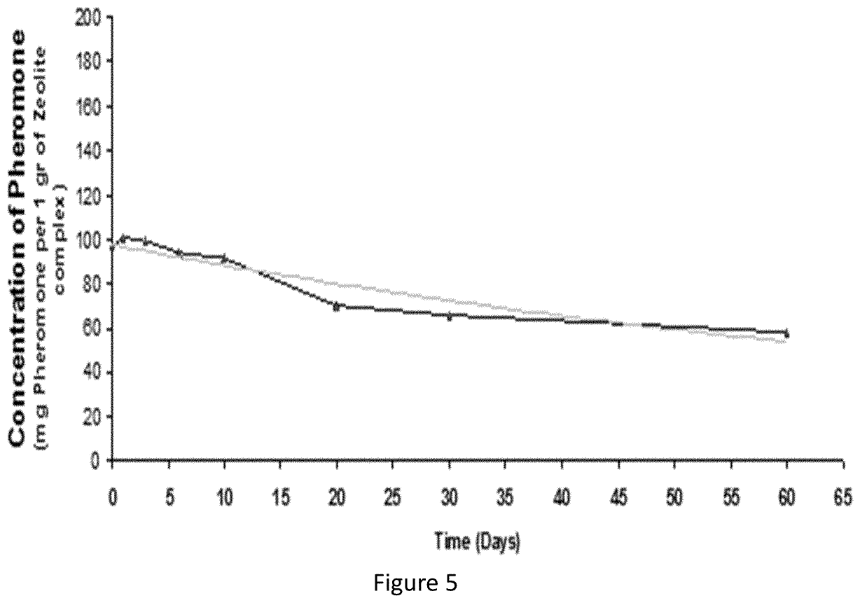

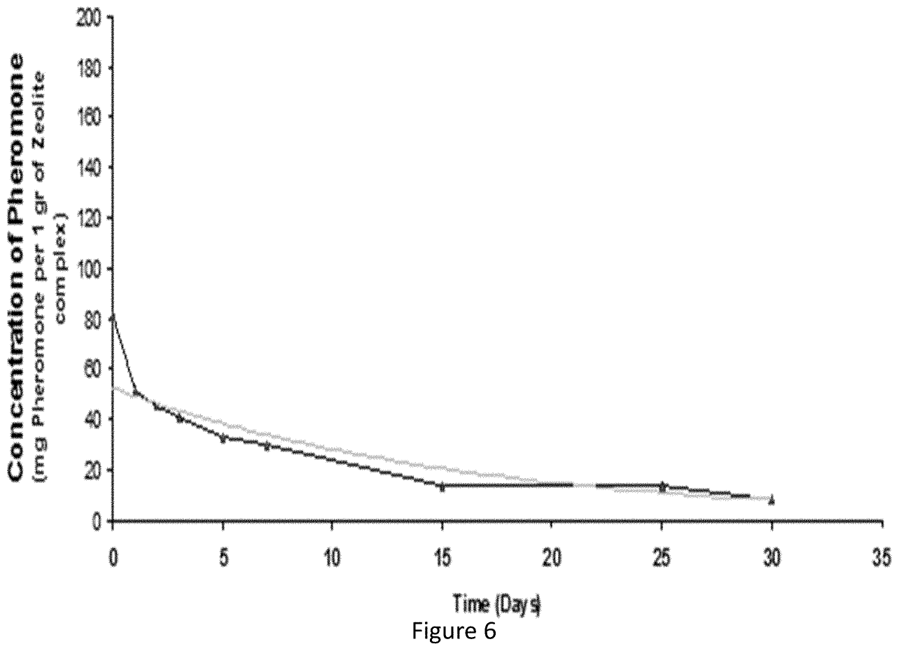

Other mesoporous host materials that are usefully slow-release, albeit lower loading, include: Al₂O₃, see FIG. 2; K-10 Montmorillonite (Na-K10), see FIG. 3, and its derivatives, such as: Al-K10, see FIG. 4; Ca-K10, see FIG. 5; Cu-K10, see FIG. 6, and combinations thereof. FIGS. 2-6 illustrate the respective loading and release of oleane from these host materials, and correspond to the data in Table 1.

K-10 has an average pore size of about 4 nm. US2007190092 relates to sustained release of a pheromone at a constant rate from clay/kaolin/zeolite. A sustained release pheromone formulation is described as containing a pheromone in a crystalline mineral; no particular limitations were placed on the crystalline mineral so long as this crystalline mineral is a mineral having a crystalline structure, and no particular limitations were placed on the pheromone used. Sepiolite, palygorskite, and montmorillonite were described being particularly preferable; however, sepiolite includes a very wide range of pores (M. J. Wilson, Rock Forming Minerals, Geological Society of London, 2013), whereas palygorskite is microporous (J. M. Cases et al., Clays and Clay Minerals, Vol. 39, No. 2, 191-201, 1991).

WO2016180738 pertains to sustained release of various pheromones from porous clay e.g., various zeolites. However, no discussion is dedicated to the pore size of the host material. The preferred clay is described to be Clinoptilolite, which is microporous, excluding particles larger than 0.4 nm (A. Farjoo et al., Chemical Engineering Science, Volume 138, 22 Dec. 2015, Pages 685-688).

WO2012072366, concerns pheromones in a rubber matrix into which support material is inserted. Molecular sieves such as silica gel are described as examples of support material, however the preferred pore sizes of the molecular sieves are described as 5 to 15 angstroms, with especially 8 to 3 angstroms, being preferred.

Therefore, the publications described above do not appear to indicate that mesoporous materials are particularly suitable for loading and release of the pheromones considered herein.

The release rates of oleane in different clathrates may greatly vary.

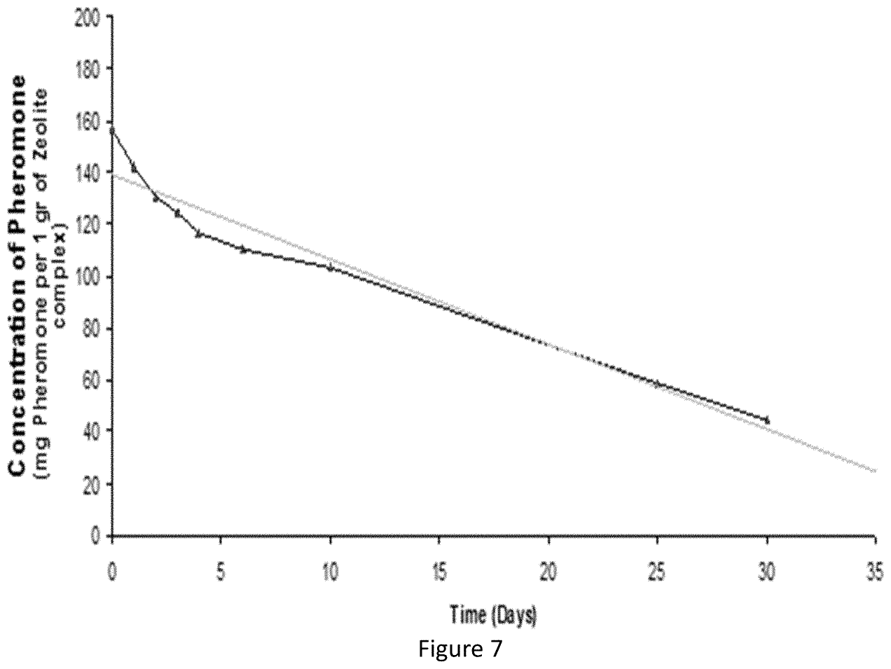

For example, FIG. 7 illustrates the loading and release of oleane from NaX (25° C.) zeolite. The points in Graph 2 represent corresponding data in Table 1 for these clathrates. Whereas like silica NaX (25° C.) zeolite has a very good loading, the release rate slopes shown in FIG. 1 and FIG. 2 are very different. Oleane NaX (25° C.) clathrates essentially finish releasing their pheromones about a month after loading.

We managed to harness this highly variable capacity in some pheromone applications to make “cocktail” embodiments characterized by an initial burst of pheromones followed by a slow and more gradual release.

The silica-pheromone clathrates and/or other slow-release clathrates may be combined with other, faster release clathrates hosting the same pheromone or others to provide variable-release compositions. The following host materials may be suitable for use for fast release and high loading of oleane or similar sized pheromones:

Na—X zeolite and its derivatives such as H—X, Zn—X and/or Ca—X and combinations thereof; K—X has slightly lower loading but has a good fast release;

Na—Y Zeolite and its derivatives, such as K—Y, Ca—Y, Zn—Y, H—Y, NH₄—Y and/or Al—Y, and combinations thereof.

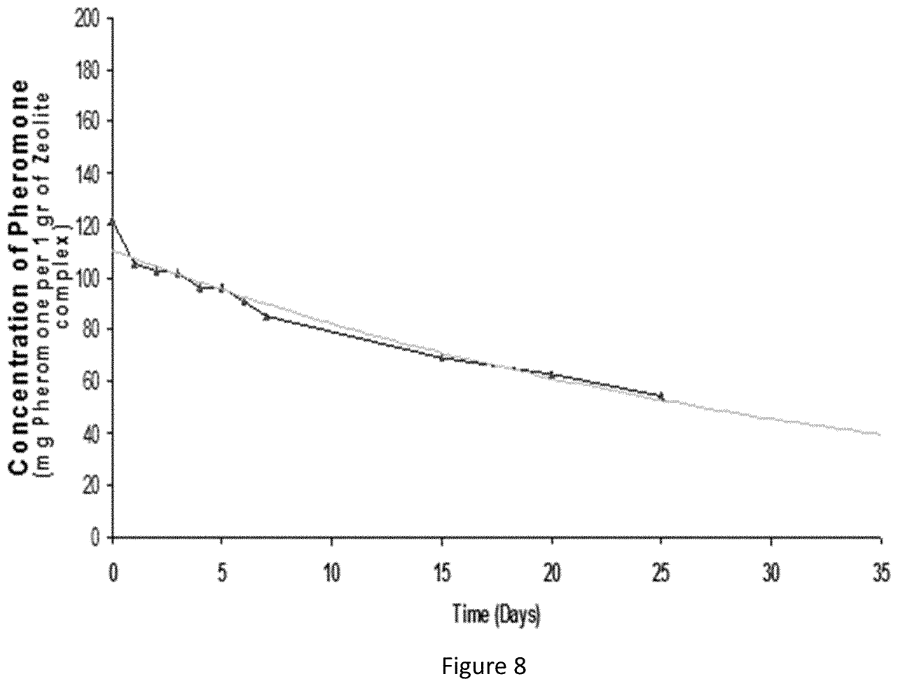

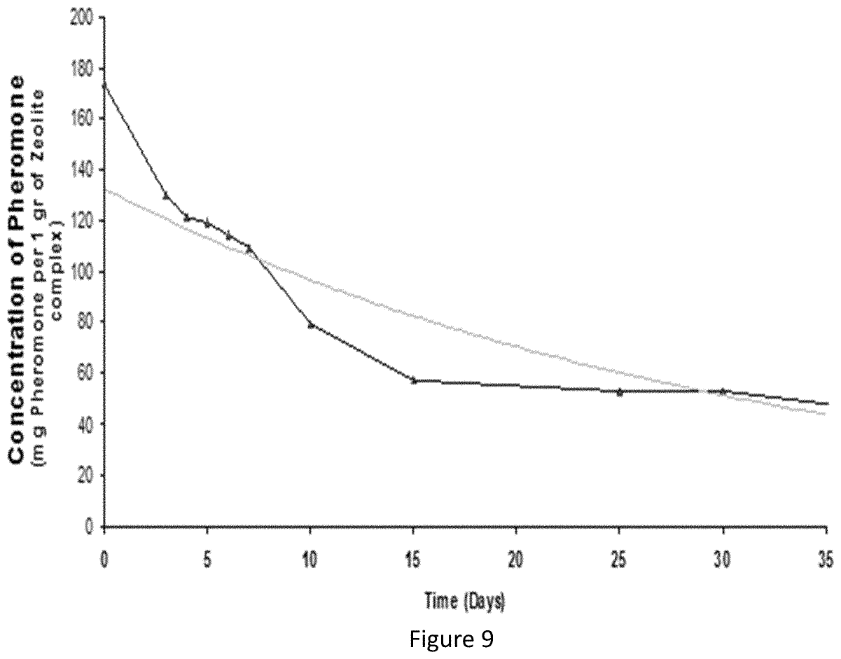

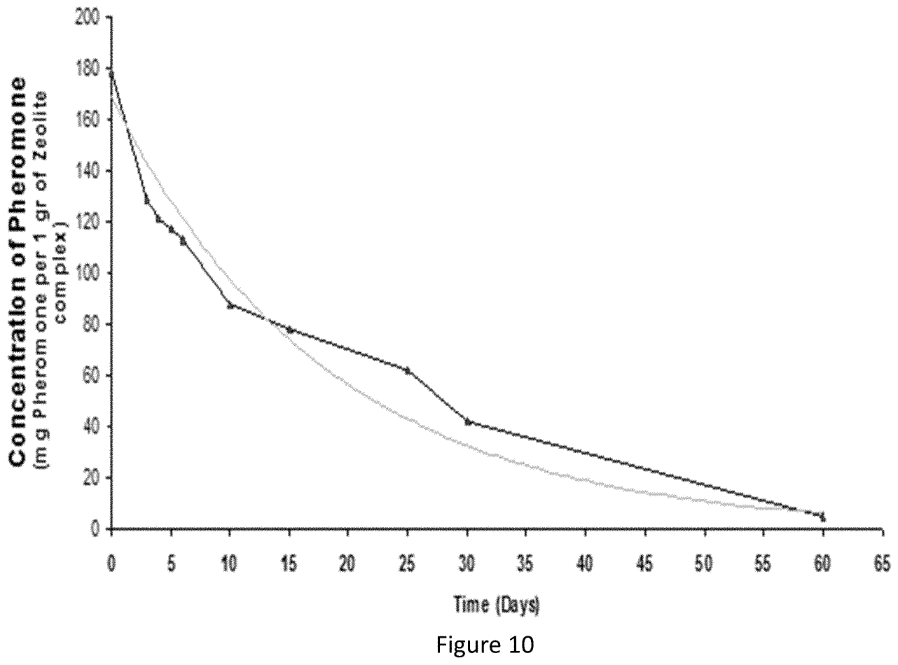

As said above, FIG. 7 illustrates the loading and release of oleane from Na—X (25° C.) zeolite. FIG. 8 shows loading and release from H—X oleane clathrates; FIG. 9 shows loading and release from Na—Y oleane clathrates; FIG. 10 shows loading and release from K—Y oleane clathrates. FIGS. 7-10 are random examples of the loading and release of Na—X zeolite and its derivatives, Na—Y Zeolite and its derivatives and correspond to the data in Table 1.

Various Na—X zeolites and/or Na—Y zeolites may be combined to provide a tailored release profile.

Other similar pheromones tested with the same host materials are listed in Table 2.

TABLE 2

| Insect Name | Pheromone | CAS |
|---|---|---|
| Dacus Oleae | 1,7-dioxaspiro-5,5- | 180-84-7 |
| | undecane | |
| Prays Oleae | Z-7-Tetradecenal | 65128-96-3 |
| Palpita unionalis | 1) E-1 1-hexadecenal | 57491-33-5 |
| | 2) E-1 1-Hexedecenyl-1- | 56218-72-5 |
| | acetate | |
| Cydia Pomonella | E,E-8,11-dodecandien-1-ol | 33956-49-9 |
| Ectomyelois Ceratoniae | Z,E-9,11,13- | 123314-23-8 |
| (Carob moth) | Tetradecatrienal | |
| Tula absoluta | E,Z,Z-3,8,11- | 163041-94-9 |
| | Tetradecatrienyl acetate | |

Preliminary tests with the pheromones listed in Table 2 and the host materials listed in Table 1 indicate a surprisingly high loading and gradual release of the pheromones when the host materials are mesoporous, in particular when the host material is silica, similar to the trend exhibited with oleane clathrates.

Note that for the treatment of the pest Palpita unionalis two pheromones should be incorporated in clathrates. Typically, a batch of clathrates hosting E-11-hexadecenal are prepared and another batch is prepared, hosting E-11-Hexedecenyl-1-acetate. The two clathrate batches are then mixed for use.

In addition, in some embodiments compositions comprising clathrates with various pheromones against various pests are mixed. For example, olives are often attacked by several of the insects listed in Table 2 and thus a mixture containing effective amounts of pheromones against these pests may be prepared.

One method of determining the amounts and types of pheromones and their mode of release includes monitoring a field or grove or orchard for the presence of pests. At least one adhesive plate or board may be placed therein, each spread or sprayed with at least one clathrate or mixture of the same.

The treatment against infestation may include positioning of mass traps containing the clathrates. Alternatively, or in addition, mating disruption may be carried out by scattering the clathrates from a vehicle or aircraft, for example.

The treatment and compositions may further include pesticides, for example spinosad. Spinosad contains a mix of two spinosids, spinosyn A, the major component, and spinosyn D (the minor component), in a roughly 17:3 ratio w/w respectively. The pesticides can be separately administered or together with the clathrates, for example the pesticides may cover and/or be hosted by the host materials.

In addition, several of the pheromones in Table 2 may require the hosting in the host material for the purpose of protection rather than, or in addition to, control of release. For example, from careful analysis of the clathrate samples over time we have surprisingly discovered several problems of stability of some of the pheromones such as oxidation, photodegradation, hydrolysis, and thermal decomposition. Accordingly, some composition embodiments comprise in the host material or adjacent thereto agents that at least partially counteract the degradation, such as antioxidants.

Some embodiments are provided as pheromone dispensers in which a carrier/host material loaded with pheromone is incorporated into a matrix made of a polymeric material such as, for example, rubber. However, typically the carrier/host material is not incorporated into such matrix. The dispensers may comprise a light protection material. For example, the Eppendorf tubes used to store the clathrate samples in the field were each wrapped in a black layer. Alternatively, particles of the composition may be coated with light-protective material.

Field Trials

### Orchard 1: Aara Organic Olive Orchard

Trial Objective

To evaluate the efficacy of controlling two major olive insect pests (Olive fruit fly, Olive moth) based on mass trapping of adult insects, by using a unique solid formation of encapsulated multi sex pheromones in same product-formulation, compared to untreated control and a sprayable formulation (suspension) of multi sex pheromones used for mating disruption, in a commercial organic olive orchard in Aara village in Israel during the season 2019-2020.

Materials and Methods for Orchard 1

The pheromones in the mesoporous carrier are the olive fruit fly pheromone, jasmine moth pheromone, and olive moth pheromone. The pheromones are each encapsulated with silica with 20% loading for the mass trapping method and 10% loading for the mating disruption method, described below.

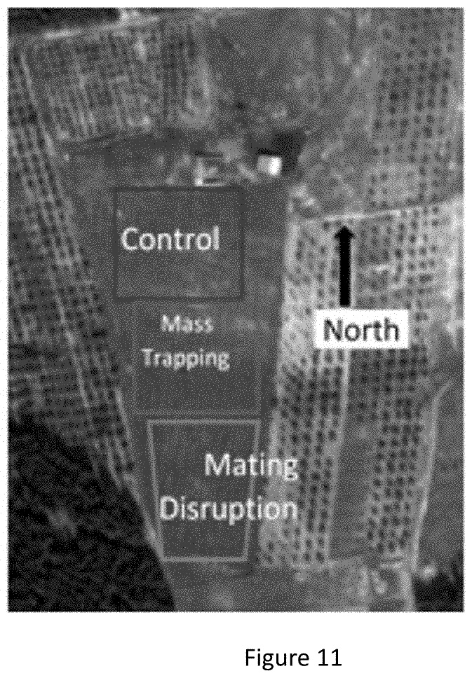

Trial location: 4 hectares of a commercial organic olive orchard owned by Yunis family in Aara village in northern Israel. The yield was aimed for organic oil production for export. The trees were irrigated by a drip system. The varieties are Barnea and Koroniki 10 years old, randomly scattered in the orchard. The field has a very active history of infection by the pests, which used to cause noticeable damage to the yield. The trial map is shown in FIG. 11.

Untreated control: commercial management of 2 hectares.

Mass trapping method: we used yellow sticky delta traps (ISCA Technologies) that each includes a dispenser of 1.5 grams of our solid encapsulated formulations (0.1 grams of each pheromone per trap). Thus 50 traps per hectare equal to 5 grams of each pheromone per hectare. The mass trap treatment area has a size of 1 hectare.

Mating disruption method: using a sprayable encapsulated formulation of multi pheromones, manually applied on thick stems by net. 50 grams of each pheromone were applied per hectare. The treatment area was 1 hectare.

The preparation of spraying suspension was done by diluting the encapsulated formulation that has 10% loading of each pheromone in water. Thus 500 gr of each capsule-pheromone was applied per hectare (1.5 kg total capsule-pheromone per hectare). The total volume of spraying solution is 10 liters per hectare. To ensure capsule-pheromone attachment to stems, Dabak™ glue [Israel] was mixed with the pesticides, and added to a spray tank in a 2% aqueous concentration. Spraying was done from a 13 liters' tank capacity back sprayer knapsack operated with a rechargeable battery. About 50 ml of solution was sprayed on each stem of a tree.

Monitoring

We collected five sticky two-sided 20-30 cm boards, yellow traps per treatment plot. Each trap includes one commercial monitoring pheromone dispenser for each insect (Supplied by Bio-Yom). These traps were replaced with new traps every 10-14 days. The old traps were taken to laboratory for counting adult insects, and identification of male and female adults.

Fruit Infestation Evaluation

Olive moth and fruit fly Infection and damage levels on fruits were evaluated by randomly harvesting 5 replicates per treatment, since each replicate has 50 fruits from 5 trees i.e., 250 fruits per treatment. The 1^{st} count was done in July 2019, a few days before the trial started. The 2^{nd} count was done during commercial harvest in November 2019. The harvested sample fruits were taken to laboratory and each insect (fruit fly or olive moth) was identified by stages (larva or pupae).

Statistical Analysis

Results were documented and later analyzed by PRISIM software using One-way Anova Tukey's multiple comparison test.

Results

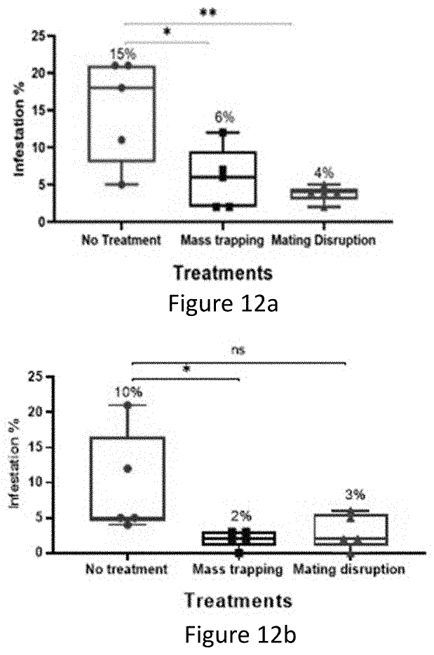

Fruit fly infection in fruits: FIG. 12a shows the infection % of fruits by olive fruit fly larva as measured at harvest time (November 2019). The two pheromone treatments are remarkably efficient in reducing and preventing infection compared to untreated control. The two types of treatments do not exhibit significant difference of efficacy from each other.

Each treatment represented in FIG. 12a has 5 points, and each point is an average of 50 measurements of fruit. All points on the graph are second counts. The first counts (not shown) indicated the infection before the trial started as a base line. Note that we also did not observe any significant difference between the treatments in the 1^{st} count. The middle line in each rectangular in FIG. 12 represents the median.

Olive Moth Infection in Fruits

FIG. 12b shows the infection % by olive moth in fruits on the day of harvest. The two pheromone treatments reduced and significantly prevented the infection in fruits by olive moth compared to untreated control. Again no significant differences were observed between the two types of pheromone treatments.

Monitoring of Olive Fruit Fly Population:

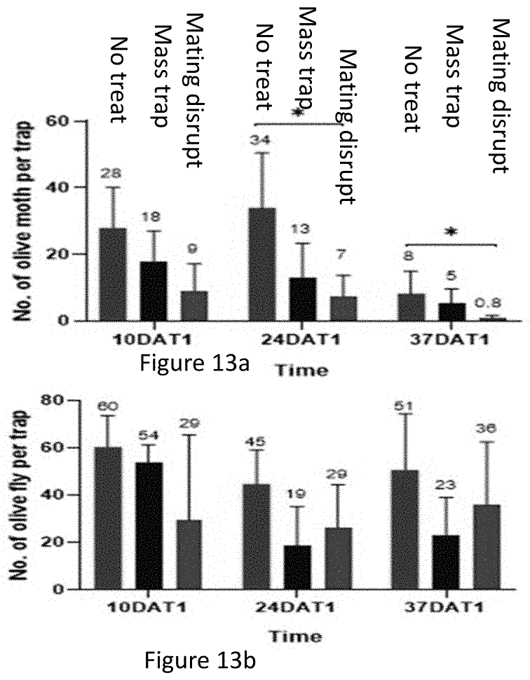

FIG. 13a illustrates the number of trapped adult olive fruit fly insects on the monitoring traps by treatments and counting, following application of treatments (10DAT1=10 days after treatment, 24DAT1=24 days after treatment, 37DAT1=37 days after treatment).

The population did not show significant correlation with infection, at 10, 24 or 37 days after treatment. Nevertheless, as indicated in FIG. 13a, we noticed a trend that the mating disruption and the mass trapping are causing lower populations in field.

Monitoring of Olive Moth Population:

FIG. 13b depicts the number of trapped adult olive moth insects in the monitoring traps by treatments and counting dates following application of treatments (10DAT1=10 days after treatment, 24DAT1=24 days after treatment, 37DAT1=37 days after treatment).

The adult number of olive moths trapped in monitoring traps 24 and 37 days after application of treatment shows correlation with the infection, and there are significant differences between pheromone treatments and untreated control. There are no significant differences between the two types of pheromone treatments.

Conclusions

The mass trapping and mating disruption treatments significantly prevented the infection in fruits by two insects (olive fruit fly and the olive moth) compared to untreated control. There were no observable significant differences between the mass trapping and mating disruption treatment methods.

There was a correlation between the monitored population of olive moths and the infection % of fruits. In these two parameters there were significant differences between the encapsulated pheromone treatment of mass trapping and control, but not significant between mating disruption and the control.

Using multi pheromone dispensers for mass trapping or sprayable multi formulations for mating disruption did not indicate any attenuation of efficacy of any pheromone of olive moth or fruit fly, since they were both effective even though they were in same formulation.

The mass-trapping formulations are considered to be efficacious with a wide range of trap models and in some embodiments the pheromone-carrier formulations are combined with a killer ingredient, for example Spinosad and/or deltamethrin.

Apparently the provided mating disruption formulation products for olive moths have a high treatment potential and are also effective as single pheromone products.

### 2. Conventional Kfar Qari Orchard

The orchard is un-irrigated.

Trial Objective

To evaluate the efficacy of controlling two key olive pests (Olive fruit fly, Olive moth) based on mass trapping of adult insects, by using a unique solid formation of encapsulated multi sex pheromones, compared to untreated control and a sprayable formulation of encapsulated multi sex pheromones used for mating disruption method, and chemically treated (Rogor) in a conventional, unirrigated olive orchard in Kfar Qari village in Israel during the season 2019-2020.

Materials and Methods

Trial location: 5 hectares of conventional olive orchard owned by Asali family in Kfar Qari village in northern Israel. The yield was aimed for oil production for local use. The trees' watering is based on. The variety is Sori, 15 years old. The field has a moderate infection history of the two insects, which used to cause some tolerable damage to yield.

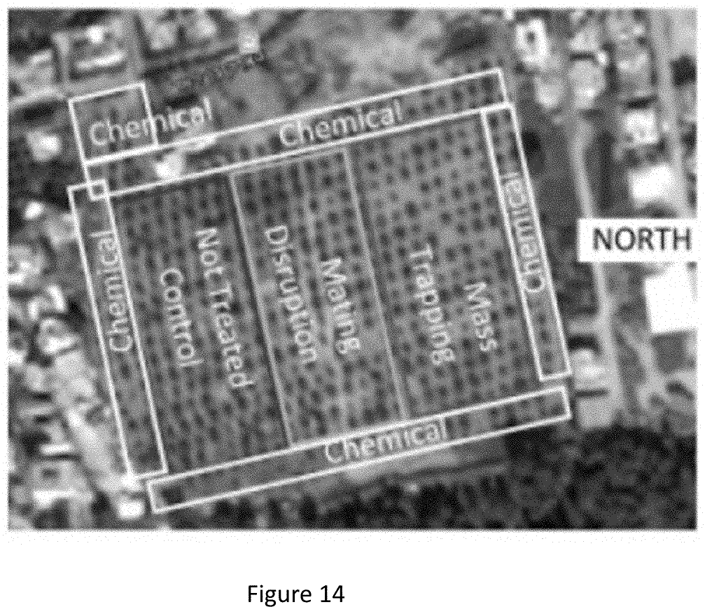

Treatments list: see trial map in FIG. 14.

Untreated control was in a commercial management of one hectare.

The mass trapping method was performed using yellow sticky delta traps that include a dispenser of solid encapsulated formulations (0.1 grams of each pheromone per trap). Fifty traps per hectare used an amount equivalent to 5 grams of each pheromone per hectare. The treatment area size was 1.5 hectares.

The mating disruption method utilized a sprayable encapsulated formulation of multi pheromones, manually applied on thick stems by net, at a dosage of 50 grams of each pheromone per hectare. The treatment area has a size of 1.5 hectares.

A chemical treatment was applied by spraying Rogor 0.1% with a spraying solution of 2000 liters per hectare. The spraying was performed with a gun nozzle with a spraying hose connected to a 1000 liters' tank sprayer operated by a tractor. The spraying was performed once in July 2019. The treatment area size was 1 hectare.

Monitoring

We located 5 sticky 2 sided 20-30 cm boards, yellow traps per treatment plot. The traps each includes a commercial monitoring pheromone dispenser of each insect (Bio-Yom supplier). These traps were replaced with new traps every 10-14 days. The old traps were taken to laboratory for counting adult insects, and identification of male and female olive fruit fly adults.

Fruit Infestation Evaluation

Olive moth and fruit fly infection and damage levels on fruits were evaluated by randomly harvesting 5 replicates per treatment, each replicate has 50 fruits from 5 trees. 250 fruits were thus examined per treatment. The 1^{st} count was performed in July 2019, several days before the trial started. The 2^{nd} count was performed during a commercial harvest in November 2019. The harvested sample fruits were taken to laboratory and each insect was identified (fruit fly or olive moth) and the stages were recorded (larva or pupae).

Statistical Analysis

Results were documented and later analyzed by PRISIM software using One-way Anova Tukey's multiple comparisons test.

Results

Fruit Fly Infection in Fruits:

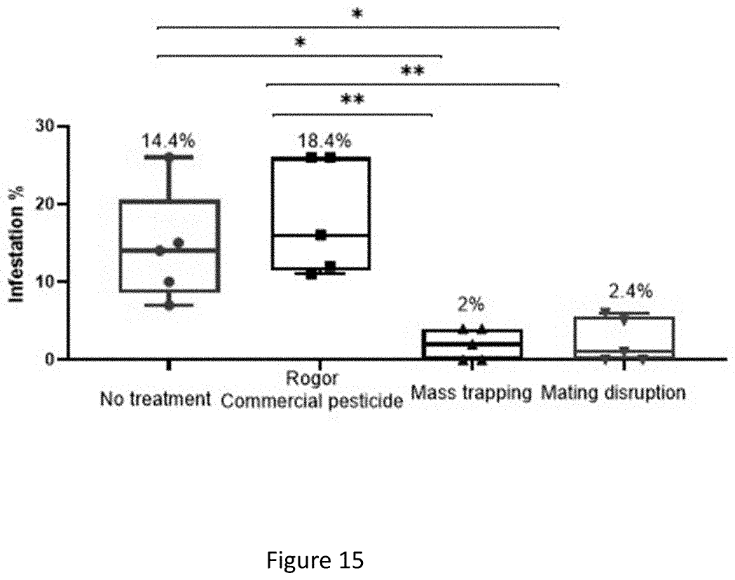

FIG. 15 illustrates the infection % of fruits by olive fruit fly larva. The two pheromone treatments are significantly efficacious in reducing and preventing infection compared to untreated control and chemical treatment, but not significant in between the two types of treatments with the pheromone clathrates. The is no apparent difference between the chemical treatment and the untreated control.

Conclusions

Mating disruption and mass trapping treatments significantly prevented the infection by fruit fly and olive moth, compared to untreated control and chemical treatment.

A chemical single treatment was not efficient in preventing infection.

Monitoring the population of both olive fly and moth did not show correlation with infection percentage of fruits.

Using multi encapsulated multi pheromone product formulations did not negatively affect the efficacy of any of the pheromones.

The present encapsulation embodiments offer the following advantages:
Upgrading the performance of active ingredients (pheromones) by improving the efficacy over an extended time.
Stabilizing the active ingredients by protecting them against humidity, oxidation, light and heat.
Enabling slow controlled release of active ingredients over time.
Extending activity of active ingredients for long period, thus enabling applying one application only per season, instead of several applications.
Preventing phytotoxicity (burning plants) of some active ingredients when applied on plants.
Allowing a combination of multi pheromones and natural active ingredients in the same formulation, to act as one product for controlling different pests in one application.
Providing easily sprayable formulations of pheromones as an innovative product for controlling insects by mating disruption.
Allowing to prepare a solid formulation, as a dispenser for controlling insects, by attracting them to devices operating by a mass trapping method.

In the description and claims of the present application, each of the verbs, “comprise,” “include” and “have,” and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A slow-release composition comprising:
first host material comprising
a mesoporous molecular sieve;
guest material within the first host material, the guest material comprising at least one pheromone, wherein the pheromone is selected from a group consisting of: 1,7-dioxaspiro-5,5-undecane; Z-7-Tetradecenal; E-11-hexadecenal; E-11-Hexedecenyl-1-acetate; E,E-8,11-dodecandien-1-ol; Z,E-9,11,13-Tetradecatrienal, and E,Z,Z-3,8,11-Tetradecatrienyl acetate, and mixtures thereof.

2. The slow-release composition of claim 1, wherein the mesoporous molecular sieve is selected from:
silica; Al₂O₃, K-10 Montmorillonite and derivatives thereof, and mixtures thereof.

3. A variable-release composition comprising:
first host material comprising a mesoporous molecular sieve;
second host material selected from a second group consisting of: Na—X and derivatives thereof, Na—Y and derivatives thereof, and mixtures thereof;
guest material within the first host material and within the second host material, the guest material comprising at least one pheromone,
wherein the pheromone is independently selected for each of the first host material and the second host material from a group consisting of: 1,7-dioxaspiro-5,5-undecane; Z-7-Tetradecenal; E-11-hexadecenal; E-11-Hexedecenyl-1-acetate; E,E-8,11-dodecandien-1-ol; Z,E-9,11,13-Tetradecatrienal, and E,Z,Z-3,8,11-Tetradecatrienyl acetate, and mixtures thereof.

4. The composition of claim 3, the mesoporous molecular sieve consisting of:
silica; Al₂O₃, K-10 Montmorillonite and derivatives thereof, and mixtures thereof.

5. The composition of claim 2, wherein the composition is not incorporated into a matrix made of a polymeric material.

6. The composition of claim 2, wherein the first host material consists of silica.

7. The composition of claim 4, wherein the first host material consists of silica.

8. The composition of claim 1, further comprising spinosids.

9. The composition of claim 8, wherein the spinosids comprise spinosyn A and spinosyn D.

10. The composition of claim 9, wherein spinosyn A and spinosyn D are in a 20/1 to 15/5 ratio respectively.

11. The composition of claim 10, wherein spinosyn A and spinosyn D are in a 20/2 to 16/4 ratio respectively.

12. The composition of claim 4, wherein Na—X and derivatives thereof is selected from a group consisting of: Na—X; H—X, Zn—X, Ca—X, K—X and combinations thereof.

13. The composition of claim 4, wherein Na—Y and derivatives thereof is selected from a group consisting of: Na—Y; K—Y, Ca—Y, Zn—Y, H—Y, NH₄—Y, Al—Y, and combinations thereof.

14. The composition of claim 1, further comprising at least one protective agent, the protective agent being effective in protecting the guest material against at least one of a group consisting of oxidation, photodegradation, hydrolysis, and thermal decomposition.

15. The composition of claim 14, wherein the at least one agent is situated in the first host material or adjacent thereto.

16. The composition of claim 14, wherein the agent is at least one antioxidant.

17. The composition of claim 14, further comprising an opaque coating on the first host material.

18. The composition of claim 4, further comprising an opaque coating on the first host material and/or second host material.

19. A dispenser comprising the composition of claim 1.

20. The dispenser of claim 19, wherein the dispenser is essentially opaque.
